(19) United States
(12) Patent Application Publication
(10) Pub. No.: US 2003/0109946 A1
(43) Pub. Date: Jun. 12, 2003

(54) Computer-aided layout and application of tape

(76) Inventors: Leif O. Erickson, River Falls, WI (US); William R. Slobotski, St. Paul, MN (US); Hung T. Tran, Woodbury, MN (US)

Correspondence Address: 3M INNOVATIVE PROPERTIES COMPANY, PO BOX 33427, ST. PAUL, MN, 55133-3427, US

(21) Appl. No.: 10/012,949

(22) Filed: Dec. 10, 2001

(51) Int. Cl. G06F 19/00

(52) U.S. Cl. 700/96

(57) ABSTRACT

In general, the invention is directed to techniques that enable conventional computer-aided design software applications to be used to precisely control application of tape. A system comprising a design software application that outputs design data defining at least one object within a multidimensional space. The design software application may comprise a computer-aided design (CAD) software application that presents a graphical user interface for manipulating the object within the multidimensional space. The system further comprises a translation module to generate instructions based on the object, and to apply tape to a surface in response to the instructions. The translation module may generate the instructions to cause the tape applicator to cut the tape based on a second object described by the data. In this manner, the invention allows any conventional design software to be used to control the layout and application of tape using a tape applicator.

### TECHNICAL FIELD

The invention relates to machine-controlled application of tape to a surface.

### BACKGROUND

Adhesive tape has been widely used in various applications ranging from protective masking to packaging. Recently, adhesive tape has been developed that can create the effect of cut glass when applied to a glass surface, such as float glass. The tape can, for example, be applied to a surface, such as glass and mirror surfaces, for a decorative effect. Virtually any item with decorative glass or mirrors can be enhanced with this type of tape including windows, kitchen cabinets, entertainment centers, tables, bookcases, buffets, curios, picture frames, vases, displays, and the like. Other example uses for such tape include surfaces of conference rooms, sidelights, restaurant booths, display areas, and lobbies in office buildings.

This type of tape is often applied in a decorative pattern, and typically has a unique structure to accent the surface. For example, the tape may be formed from a transparent optical film made having a smooth first surface and a second structured surface for providing a simulated beveled appearance. The Accentrim™ tape from Minnesota Mining and Manufacturing Company (3M), of St. Paul, Minn., is one example of such a tape.

### SUMMARY

In general, the invention is directed to computer-aided techniques for automating the layout and application of tape to a surface. More specifically, the invention is directed to techniques that enable conventional computer-aided design software applications to be used to precisely control application of tape.

In one embodiment, the invention is directed to a system comprising a design software application that outputs design data defining at least one object within a multidimensional space. The system further comprises a translation module to generate instructions based on the object, and to apply tape to a surface in response to the instructions. The design software application may comprise a computer-aided design (CAD) software application that presents a graphical user interface for manipulating the object within the multidimensional space. The object may comprise, for example, a centerline defining a path within the multidimensional space. The translation module may generate the instructions to cause the tape applicator to cut the tape based on a second object described by the design data. The design data produced by the design software application may describe, for example, one or more dashed lined defining paths along which the tape applicator performs cutting operations.

In another embodiment, the invention is directed to a method comprising receiving design data defining a set of objects within a multidimensional space. The method further comprises generating instructions based one or more of the object, and controlling a tape applicator to apply tape to a surface in response to the instructions. For example, one of the objects may define a first path within the multi-dimensional space, and the method may comprise mapping the multi-dimensional space to the surface, and generating instructions to cause the tape applicator to apply the tape to the surface along the first path. In addition, one of the objects may define a second path within the multi-dimensional space, and the method may comprise, and generating instructions comprises generating instructions to cause the tape applicator to cut the tape along the second path.

The invention may be capable of providing a number of advantages. For example, the invention allows any conventional design software to be used to control the layout and application of tape using a tape applicator. More specifically, the invention provides a unique protocol by which conventional design objects, such as centerlines and dashed lines, can be used to develop detailed patterns for tape application. The translation module parses the output from the design software and generates the necessary instructions to control application of the tape to a surface. In this manner, a user can define the pattern using a graphical interface presented by the design software application, and using standard design objects commonly available within conventional design software applications.

Other advantages of the invention include the flexibility to design virtually any pattern using tape segments. The tape segments can be defined within the design software application to have ending points defined by one or more cuts at any angle. This allows the user to combine the tape segments in unique ways to form almost any desired pattern. Furthermore, during generation of the instructions, the translation module processes the design data to ensure identification of any errors within the pattern definition. In addition, the translation module generates the instructions to ensure a minimum gap between segments to compensate for contraction and expansion due to changes within the environment.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating a system that facilitates the computer-aided layout and application of tape according to the principles of the invention.

FIG. 2 is a block diagram illustrating an example embodiment of a tape applicator.

FIG. 3 illustrates an example pattern created by a user by interacting with a design software application, such as a computer-aided design (CAD) software application.

FIG. 4 illustrates an article after application of tape according to the pattern illustrated in FIG. 3.

FIG. 5 provides a more detailed view of a pattern created by a user.

FIG. 6 illustrates an article after application of tape according to the pattern illustrated in FIG. 5.

FIG. 7 provides a detailed view of another pattern created by a user.

FIG. 8 illustrates an article after application of tape according to the pattern illustrated in FIG. 7.

FIG. 9 is a flowchart providing an overview of computer-aided layout and application of tape according to the principles of the invention.

FIG. 10 is a flowchart illustrating in further detail the operation of a translation module when generating instructions to control the tape applicator.

FIG. 11 is a flowchart illustrating in further detail the operation of the translation module when parsing design data to generate tape data and cut data.

FIGS. 12-14 are flowcharts illustrating in further detail the operation of the translation module when generating instructions to control the tape applicator based on the tape data and the cut data.

### DETAILED DESCRIPTION

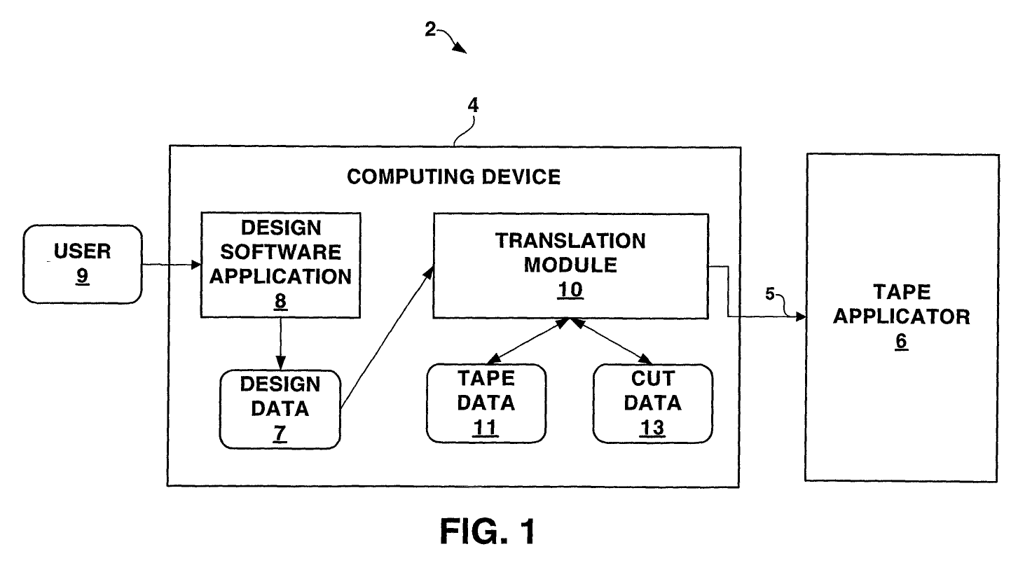

FIG. 1 is a block diagram illustrating an example system 2 that facilitates the computer-aided layout and application of tape. As described in detail below, system 2 includes a computing device 4 that provides a computer-aided design (CAD) environment for creating patterns within a multidimensional space. Based on the patterns, computing device 4 outputs instructions 5 for controlling the application of tape to a surface by tape applicator 6. Computing device 4 may be communicatively coupled to tape applicator 6 via a serial connection, for example, a network connection, or any other mechanisms for communicating digital information.

Computing device 4 provides an operating environment for translation module 10 and design software application 8. Design software application 8 provides a CAD environment for use by a user 9. Computing device 4 may comprise, for example, a computer having specialized hardware for supporting computer-aided design, a generalized workstation, a personal computer, laptop computer, or the like. Computing device 4 may include a variety of components (not shown) to facilitate the design of the pattern including a high-quality graphics monitor, one or more pointing devices such as a mouse, a light pen, or digitizing tablet for drawing, and a special printer or plotter for printing design specifications.

By interacting with computing device 4, user 9 can graphically create a pattern for applying tape to a surface. In particular, by interacting with design software application 8, user 9 can define one or more tape segments within a multidimensional space, such as a two-dimensional space. To create the pattern, user 9 can graphically place design objects of a first type within the multidimensional space to define a set of paths (vectors) along which tape applicator 6 is to apply tape. Next, user 9 can graphically place design objects of a second type within the multidimensional space to define a set of paths along which tape applicator 6 is to perform cutting operations. In this manner, user 9 can precisely control the starting location and the ending location of each tape segment, and the cuts therein, thereby defining a pattern.

Advantageously, user 9 can create the pattern by selecting and placing design objects that are readily available within a conventional CAD system. Universally, line types used within a conventional CAD system typically include: solid, dashed, centerline and phantom line types. According to the invention, specific line types are used to define specific functions. User 9 may, for example, use line types such as a centerline as the first type of object, and a dashed line as the second type of object. In other words, user 9 may graphically place a centerline to define a path for application of tape, and may place a dashed line to define a path for a cutting operation. Additionally, other line types, such as solid lines and phantom lines, may be used to facilitate drawing of the pattern by providing a rendered view of the pattern to the user 9. In other words, user 9 may combine lines for controlling tape applicator 6 with lines for rendering and displaying the pattern within the design environment. Use of the additional line types will not affect the output of instructions 5.

By making use of standard objects, design software application 8 may be any conventional design software application and need not be specialized for controlling tape applicator 6. Examples of conventional CAD software applications include AutoCAD™ from Autodesk, Inc. of San Rafael, Calif., MicroStation™, QikDraw™, and Visio™ by Microsoft Corporation of Redmond, Wash. Any conventional CAD software applications capable of exporting data to a neutral format, such as DXF format, may be used. Furthermore, design software application 8 need not be a fully featured CAD software application, but may be conventional mapping and graphics design software, such as CorelDraw™, Surfer™, and World Construction Set™.

In response to input from user 9, design software application 8 outputs design data 7 that describes the pattern created by user 9. Specifically, design data 7 describes the objects placed by the user, including the locations and orientations of the objects within the multidimensional space. Design data 7 may conform to a standard output format for a conventional design software application, such as the DXF output format used by AutoCAD.

Translator module 10 accesses design data 7 and generates instructions 5 for controlling tape applicator 6 based on the objects. In particular, translator module 10 parses design data 7 to identify the described objects. Based on the attributes of the objects, translator module constructs tape data 11 and cut data 13 representative of the pattern. Based on tape data 11 and cut data 13, translation module 10 generates the appropriate instructions 5 to direct tape applicator 6 to apply tape to a surface to form the described pattern. For each centerline, for example, translator module 10, generates one or more instructions 5 to cause tape applicator 6 to apply tape to a surface along a path described by the centerline. Similarly, for each dashed line, for example, translator module 10, generates one or more instructions 5 to cause tape applicator 6 to perform a cutting operation along a path described by the dashed line.

As illustrated, translation module 10 comprises a software module executing in the operating environment provided by computer device 4. Translation module 10 may be, for example, a stand-alone executable software program, or one or more software modules integrated into, and invoked by, design software application 8. However, translation module 10 need not be implemented entirely in software, and may be implemented in whole or in part by dedicated hardware, firmware, or any combination thereof.

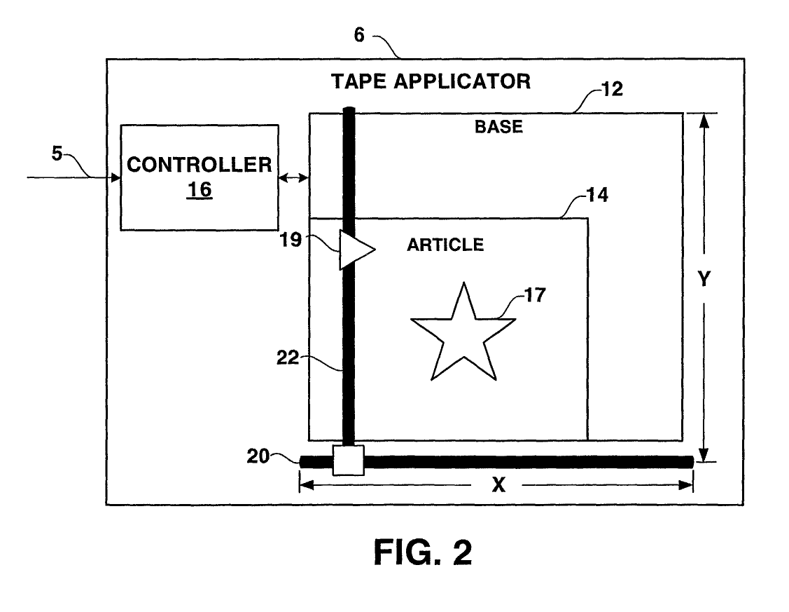

FIG. 2 is a block diagram illustrating an example embodiment of tape applicator 6 in further detail. Controller 16 receives instructions 5 from computing device 4 and, in response, controls application of tape to a surface of article 14. In particular, controller 16 receives the instructions 5 from translation module 10 and, with the use of actuators (not shown), moves tape head 19 to different locations within base 12 to apply tape to the surface of article 14. Article 14 may be, for example, a sheet of glass, a mirror, or the like.

Based on the instructions 5, controller 16 typically directs tape head 19 to apply a first length of tape to article 14, and to cut the applied tape to allow removal of a portion of the tape from article 14. Next, controller 16 directs tape head 19 to move to another location on base 12 to apply a second length of tape to the surface of article 14. In this manner, controller 16 controls tape head 19 to apply tape to article 14 to form pattern 17, as developed by user 9 using design software application 8.

The tape applicator 6 includes support arms 20, 22 for supporting and moving the tape head 19 to different locations on the base 12. Specifically, support arm 20 extends along an x-axis direction of base 12, while support arm 22 extends along a y-axis of base 12. To move tape head 19 to a new location on the base 12, controller 16 may engage one or more actuators to move tape head 19 in the x-axis direction, the y-axis direction, or both.

System 2 and tape applicator 6 may be especially useful for applying decorative tape, including optical film, to a sheet of glass to form glass having a simulated etched, grooved, or beveled appearance. The optical film may appear to have a single bevel or multiplied bevels. For example, the optical film may appear to have a “V-groove.” Such tapes are commercially available as 3MTM Accentrim™ Tape, series B200 (V-groove tape) and series B100 (edge bevel tape), from 3M Company, located in St. Paul, Minn.

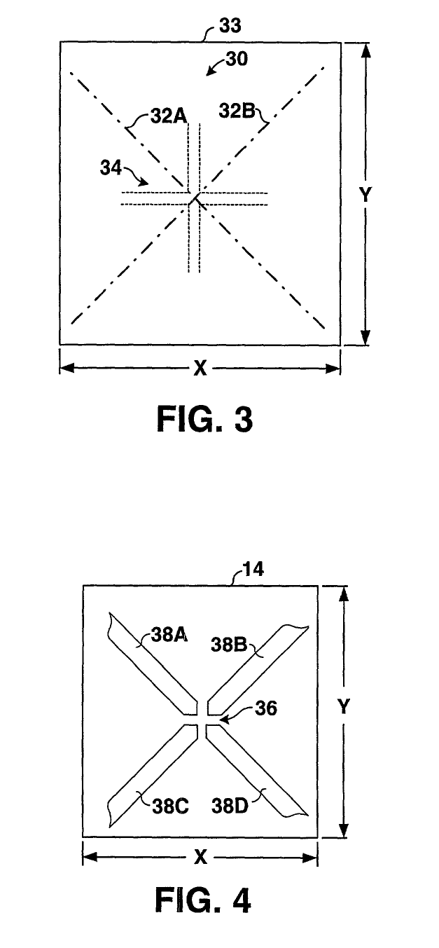

FIG. 3 illustrates an example pattern 30 created by user 9 by interacting with design software application 8. Specifically, pattern 30 includes a set of centerlines 32A and 32B, as well as a set of dashed lines 34, oriented within a two-dimensional space 33 presented by software application 8. In particular, centerlines 32A and 32B define a first path and a second path, respectively, within two-dimensional space 33 for application of tape. Dashed lines 34 define paths within two-dimensional space 33 for cutting operations. To define each path, user 9 interacts with design software application 8 to select a corresponding drawing object, such as a centerline or a dashed line, and graphically place the drawing object at the desired location and orientation within the two-dimensional space 33.

FIG. 4 illustrates article 14 after application of tape by tape applicator 6 according to the pattern 30 illustrated in FIG. 3. In particular, translation module 10 maps the two-dimensional space 33 described by design software application 8 to a coordinate system maintained by tape applicator 6 for application of tape to the surface of article 14. Next, translation module 10 generates instructions directing tape applicator 6 to apply the tape along the paths defined by centerlines 32A and 32B, and to perform cutting operations along the paths defined by dashed lines 34. Specifically, tape applicator 6 applies a first length of tape along the path defined by centerline 32A, and cuts the tape to form segments 38A and 38D. After removal of the cut tape, tape applicator 6 applies a second length of tape along the path defined by centerline 32B, and cuts the tape to form segments 38B and 38C.

In one embodiment translation module 10 generates the instructions to direct tape applicator 6 to form gaps, such as gap 36, of at least a predefined width between any two intersecting centerlines. This may be advantageous in compensating for natural expansion and contraction of the tape due to variances in environmental conditions. In another embodiment, the gaps are entirely controlled by the placement of the cuts by the user without regard to a minimum width.

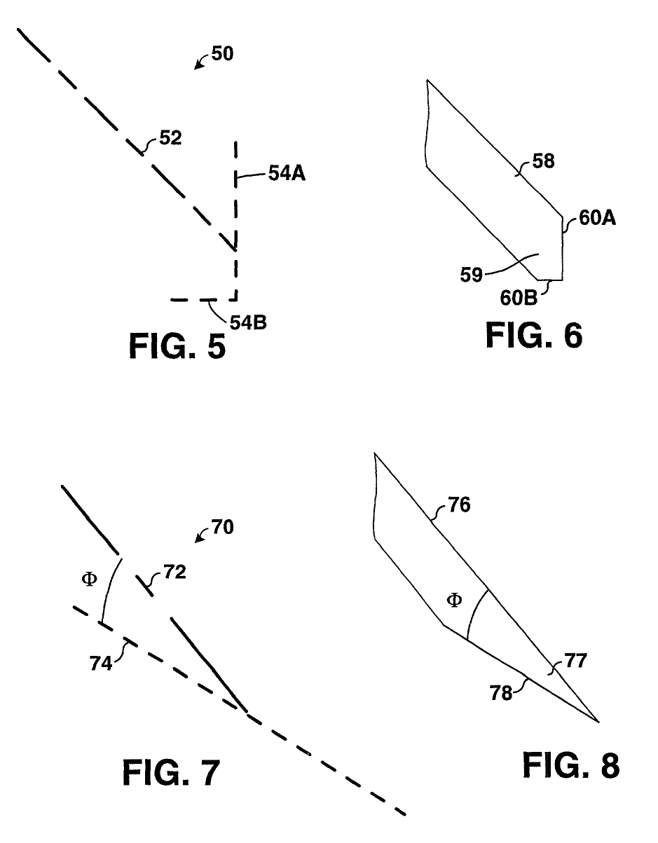

FIG. 5 provides a more detailed view of an example pattern 50 having a centerline 52 and dashed lines 54A and 54B. In particular, pattern 50 illustrates the flexibility of system 2 in that all dashed lines need not intersect centerlines. Dashed line 54B, for example, does not directly intersect centerline 52, but connects with dashed line 54A. This feature provides the user with more flexibility when designing patterns in that all tape segments need not end with a single cut. FIG. 6 illustrates application of tape by tape applicator 6 based upon pattern 50. 7 Notably, tape segment 58 includes an end 59 defined by a first edge 60A and a second edge 60B corresponding to dashed lines 54A and 54B, respectively.

FIG. 7 illustrates another example pattern 70 having a centerline 72 and a single dashed line 74. Pattern 70 illustrates another feature of system 2 in that a dashed line need not be perpendicular to a centerline, but can provide a cut path at an angle Φ from the centerline. FIG. 8 illustrates application of tape by tape applicator 6 based upon pattern 70. Notably, tape segment 76 includes an end 77 formed by edge 78 at an angle Φ from the application path of tape segment 76.

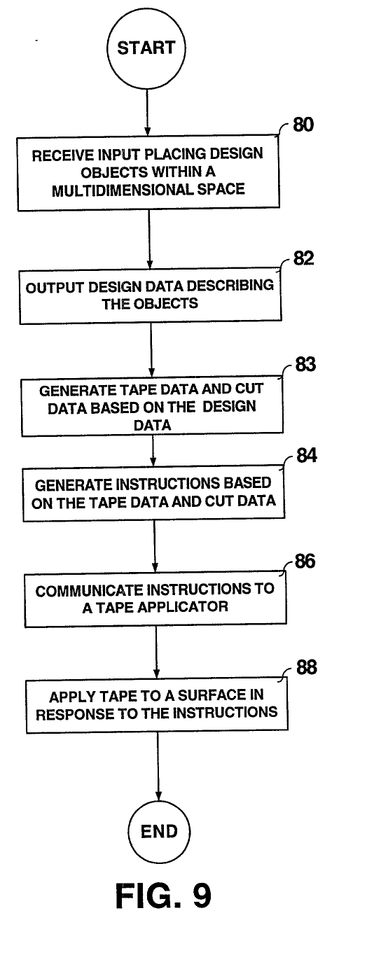

FIG. 9 is a flowchart providing an overview of the computer-aided layout and application of tape according to an embodiment of the invention. Initially, design software application 8 receives input from user 9 that describes pattern 17 for application of tape to article 14 (80). In particular, by interacting with design software application 8, user 9 can define one or more tape segments within in a multidimensional space, such as a two-dimensional space. To create the pattern, user 9 can graphically place design objects of a first type and a second type; such as centerlines and dashed lines, within the multidimensional space. As described above, the objects to define one or more paths along which tape applicator 6 is either to apply tape or to perform a cutting operation.

In response to interaction from user 9, design software application 8 outputs design data 7 that describes the objects selected and positioned within the multidimensional space by user 9 (82). Translator module 10 accesses constructs tape data 11 and cut data 13 fro design data 7 (83), and generates instructions 5 for controlling tape applicator 6 based on the objects (84). Computing device 4 communicates instructions 5 to tape applicator 6 (86), which applies tape to article 14 in response (88).

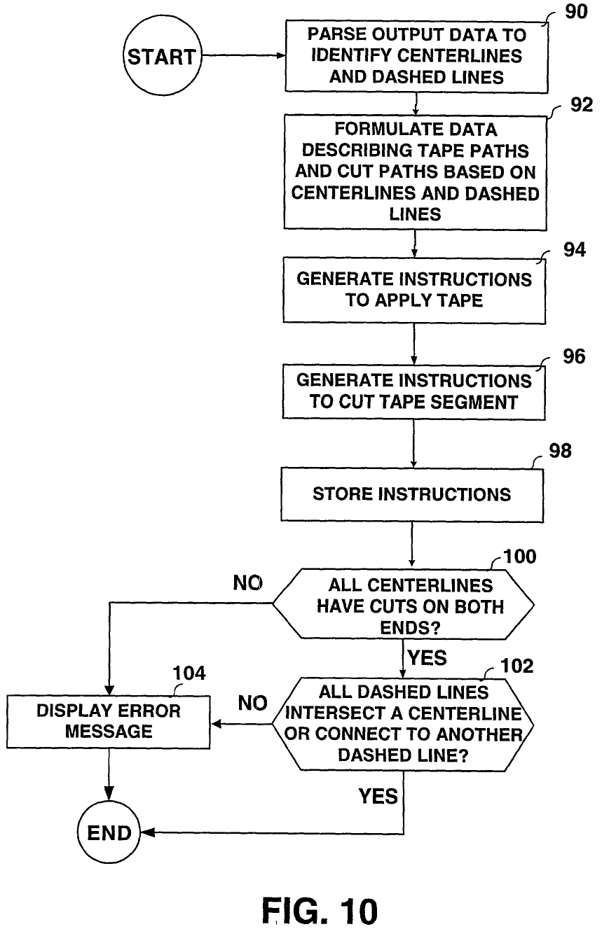

FIG. 10 is a flowchart illustrating in further detail the operation of translation module 10 to generate instructions for controlling tape applicator 6. Initially, translation module 10 parses design data 7 generated by design software application 8 and identifies any supported design objects, such as centerlines and dashed lines (90).

After identifying the design objects described within design data 7, translation module 10 formulates a set of tape paths and a set of paths for cutting operations based on the identified objects (92). As described in detail below, translation module 10 determines a starting location, an ending location, and an angle of application for the tape segments from the design objects describing centerlines. Similarly, translation module 10 determines a starting location, an ending location, and an angle for the cutting operations from the design objects describing dashed lines. Translation module 10 stores the determined information as tape data 11 and cut data 13. In one embodiment, translation module 10 may generate two array data structures to store data descriptive of the tape segments and the cuts.

Next, translation module 10 generates instructions directing tape applicator 6 to form the individual tape segments (94), and generates instructions to perform the specified cutting operations (96). For each tape segment, translation module 10 determines a tape width. In particular, translation module 10 determines a length of a normal line extending from the selected centerline to the farthest endpoint of the dashed lines that define its ends, and determines the width of the tape to be applied based on the length of the normal. In this manner, the user can readily specify different tape widths using design software application 8 by controlling the lengths of the dashed lines.

After generating the instructions, translation module 10 may store the instructions for subsequent communication to tape applicator 6 (98). Alternatively, translation module 10 may communicate the generated instructions 5 directly to tape applicator 6 for immediate or subsequent use.

Translation module 10 may provide output to user 9 indicated whether any error conditions exist with the pattern described by the design objects of design data 7. For example, translation module 10 may determines whether the ends of each centerline defined by design data 7 intersect with at least one dashed lines (100). In other words, translation module 10 verifies that each tape segment to be applied is properly cut on each end. If not, translation module 10 displays an error message (104).

In addition, translation module 10 may confirm that each dashed line intersects a centerline either directly, or via a path formed by one or more other dashed lines, as illustrated in FIG. 6 (102). In this manner, translation module 10 verifies that the user has incorrectly defined any cutting operations. If one or more dashed lines fail to meet this criterion, translation module 10 displays an error message (104).

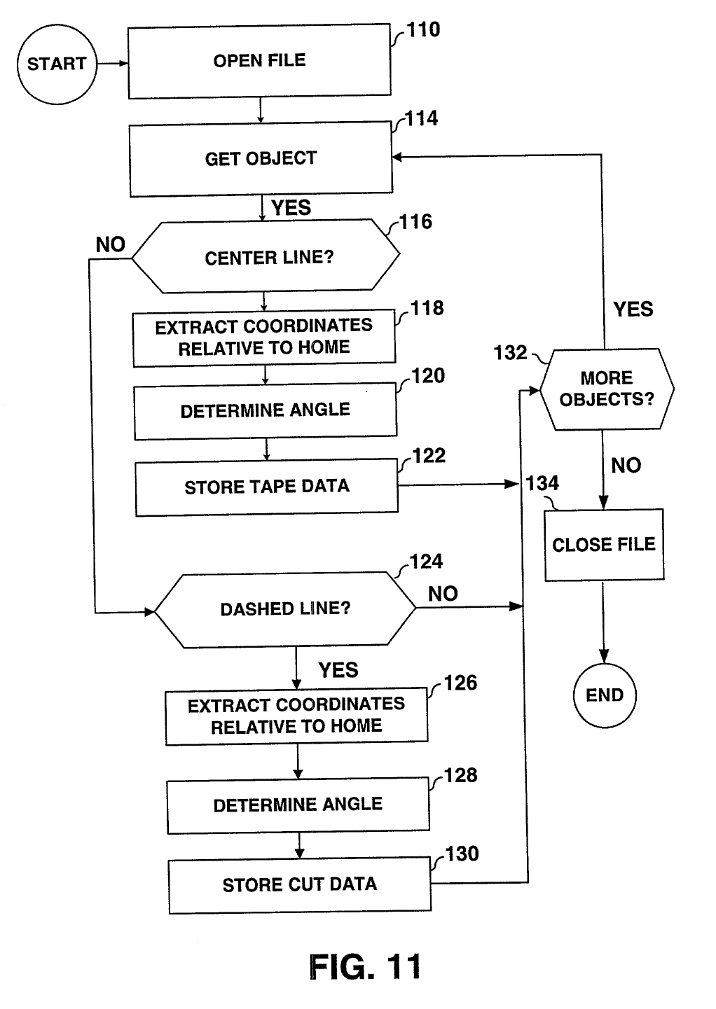

FIG. 11 is a flowchart illustrating in further detail the operation of translation module 10 when parsing output design data 7 to generate tape data 11 and cut data 13. Initially, translation module 10 accesses design data 7, such as by opening a data file stored on a computer-readable medium (110). Next, translation module 10 reads a first object from the file (114) and determines whether object describes a centerline (116). For example, the following illustrates a typical format for describing a line within a DXF data file produced by AutoCAD:

AcDbEntity, 806, LineType, Number, AcDbLine, 10, XSTART, 20, YSTART, 30, 0.0, 11, XSTART, 21, YSTART, 31, 0.0, 0, LINE, 5

For example, the following set of data:

AcDbEntity, 806, CENTER, 100, AcDbLine, 10, 1.5, 20, 1.6, 30, 0.0, 11, 2.5, 21, 2.6, 31, 0.0, 0 describes a centerline having a starting location of (1.5 ,1.6) and an ending location of (2.5, 2.6).

If the retrieved design object is a centerline, translation module 10 formulates data describing a tape segment by extracting the starting and ending coordinates (118) relative to a HOME origin of (0, 0) for the centerline, and determining an application angle. (120). Based on the application angle and tape applicator capabilities, translation module 10 determines a direction to lay the tape (120). For example, for an application angle between 90 and 180 degrees, translation module 10 may determine that tape applicator should lay the corresponding tape segment from lower right to upper left relative to base 12. Next, translation module 10 stores the determined coordinates and application angle for the tape segment within tape data 11 (122). In one embodiment, translation module 10 maintains an array data structure in which each element of the array stores information for a tape segment as determined based on design objects within design data 7.

If the retrieved design object is not a centerline (no branch of 116), translation module 10 determines whether object describes a dashed line (124). If the retrieved design object is a dashed line, translation module 10 formulates data describing a cutting operation by extracting the starting and ending coordinates relative to the origin, for the dashed line (126) and determining an angle. (128). Next, translation module 10 stores the determined coordinates and application angle for the cutting operation within cut data 13 (130). In one embodiment, translation module 10 maintains another array data structure in which each element of the array stores information for a cutting operation as determined by translation module 10 based on design objects within design data 7.

After processing the design object, translation module 10 determines whether design data 7 contains additional design objects (132). If so, translation module 10 retrieves the next design object (114) and determines whether the design object is a centerline (116) or a dashed line (124). In this manner, translation module processes all of the design objects within design data 7 to construct tape data 11 and cut data 13.

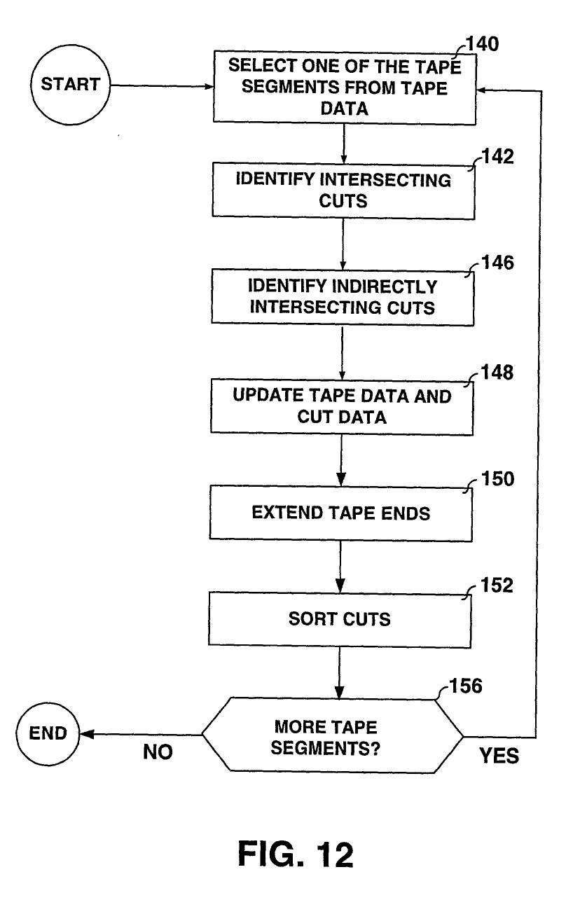

FIGS. 12-14 are flowcharts illustrating in further detail the operation of translation module 10 when generating instructions based on tape data 11 and cut data 13. Referring to FIG. 12, translation module 10 accesses the stored tape data 11 and selects a first tape segment (140). In one embodiment, for example, translation module 10 selects a first element of the array storing data describing the tape segments.

Next, translation module 10 traverses the stored cut data 13 to determine any cuts that directly intersect the selected tap segment (142). In particular, translation module 10 examines the starting and ending coordinates for the selected tap segment to the starting and ending coordinates for the cuts and determines whether the path for the tape segment intersects any of the paths for the cuts. Similarly, translation module determines any cuts that may indirectly intersect the selected segment by way of one or more other cuts (146).

Upon identifying the cuts, translation module 10 updates the stored tape data 11 and cut data 13 (148). In particular, for each tape segment, translation module 10 stores the number of directly or indirectly cuts, and stores data associating the cuts with the corresponding tape segments. In addition, translation module 10 updates the starting and ending coordinates for at least the first cut based on the calculated intersection with the corresponding tape segment. In this manner, translation module 10 ensures that the cutting operation begins on the tape and not on the surface of article 14.

Next, translation module 10 may calculate new coordinates for the ends of the tape depending upon whether any of the cuts intersect at an end of the tape segment (150). Specifically, translation module 10 may extend the length of the tape segment based on the angle of the cut intersecting the end of the tape based on the following formula:

$$L = ABS ( \frac{0.5 * W}{tan ( {Φ}_{C} - {Φ}_{T} )} )$$

where L equals the length of the extension, W equals the width of the tape, Φ_{C} equals the angle of the cut, and Φ_{T} equals the angle of the tape. Notably, translation module 10 need not extend the length of the tape for cuts that intersecting the tape end orthogonally.

Finally, translation module 10 sorts the cuts of cut data 13 that intersect the selected tape segment (152). Translation module 10 may, for example, apply a bubble sort algorithm to the stored cut data to arrange the cuts in order from the end of the tape to the start of the tape. After sorting the cuts for the selected tape segment, translation module 10 continues to traverse the stored tape data until all of the tape segments have been processed (156).

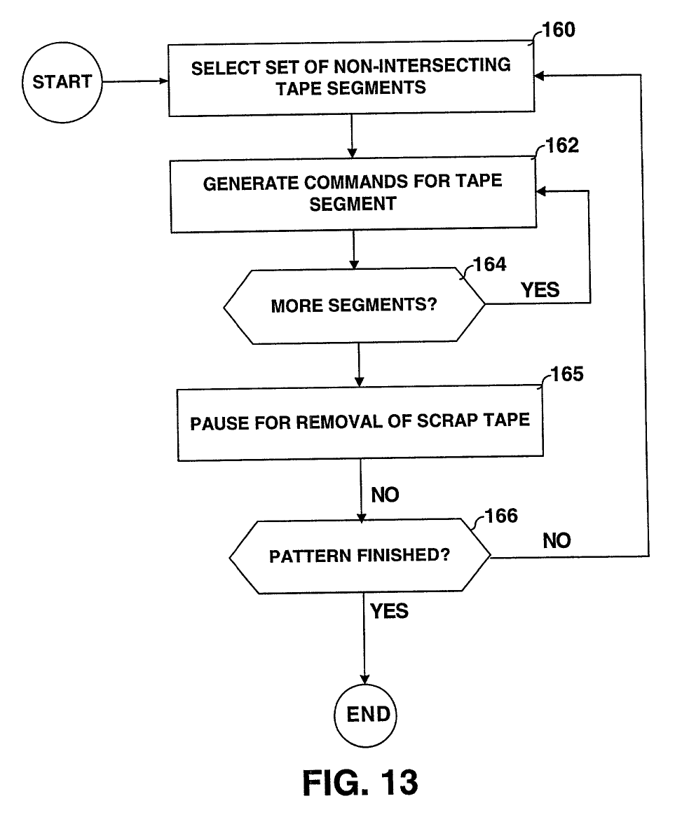

FIG. 13 is a flowchart illustrating in further detail the operation of translation module 10 when generating instructions after constructing and processing tape data 11 and the cut data 13. Specifically, translation module 10 traverses the stored tape data 11 and identifies a set of non-intersecting tape segments for which instructions 5 have not already been completed (160). For example, translation module 10 may select a first tape segment from tape data 11 for which instructions 5 have not already been completed, and may traverse tape data 11 to identify all other tape segments that to not intersect the first tape segment and for which instructions 5 have not been completed.

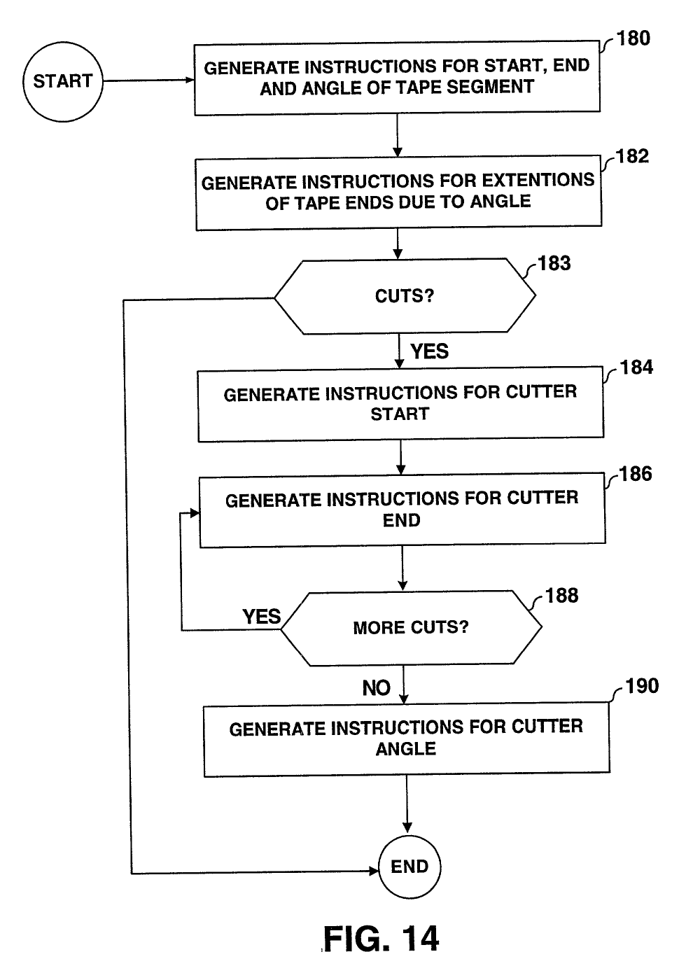

After identifying the set of segments, translation module 10 generates instructions 5 directing tape applicator 6 to apply tape along each path (162, 164). During the application of each segment, as illustrated below in reference to FIG. 14, tape applicator 6 performs all corresponding cuts intersecting the tape segment. By selecting non-intersecting tape segments, tape translation module 10 ensures that applicator 6 will not apply a tape segment on top of another tape segment. After applying and cutting the non-intersecting tape segments, translation module 10 generates instructions 5 directing tape applicator 6 to pause for manual removal of scrap tape portions that have been cut from the tape segments (165). In this manner, tape applicator 6 allows for removal of a scrap portion from a tape segment prior to applying an intersecting tape segment. Translation module 10 continues the process until traversing all of tape data 11, i.e., until instructions have been completed for forming the entire pattern (166).

FIG. 14 is a flowchart illustrating in further detail the operation of translation module 10 to generate instructions for a single tape segment selected from tape data 11 (162 of FIG. 13). The format and order of instructions may vary based on the requirements of controller 16 of tape applicator 6. In this example, it is assumed that controller 16 receives instructions for a tape segment as follows.

Tape Segment Start X, Tape Segment Start Y, Tape Application Angle, Tape Segment End X, Tape Segment End Y, Tape End Extend, Tape Start Extend,

Cutter Down X, Cutter Down Y,

Cut End X, Cut End Y,

Cut End X, Cut End Y,

. . .

Cut End X, Cut End Y,

Cut Angle

In this format, the instructions can define a complete tape segment and zero or more cuts to be applied to the tape segment.

Initially, translation module 10 retrieves data from tape data 11 for the tape segment and generates instructions specifying the starting coordinates, ending coordinates and application angle of the tape segment (180). Next, translation module 10 retrieves data from tape data 11 for the tape segment and generates instructions for extending tape ends due to the angle of cut (182).

If tape data 11 indicates that the tape segment has one or more cuts (183), translation module 10 retrieves data from tape data 11 for the tape segment and generates instructions for precise placement of a cutter of tape applicator 6 (184). Next, translation module 10 retrieves data from cut data 13 and generates instructions for one or more cutting operations (186, 188), and instructions for a cutter angle (190).

Various embodiments of the invention have been described. These and other embodiments are within the scope of the following claims.

1. A system comprising:
a design software application executing within a operating environment of a computer, wherein the design software application outputs design data defining at least one object within a multidimensional space;
a translation module to generate instructions based on the object; and
a tape applicator coupled to the computer, wherein the tape applicator applies tape to a surface in response to the instructions.

2. The system of claim 1, wherein the object comprises a line segment.

3. The system of claim 2, wherein the translation module generates instructions to cause the tape applicator to apply a length of tape based on the length of the line segment.

4. The system of claim 1, wherein the translation module generates instructions to cause the tape applicator to form a gap of at least a predetermined length between segments of the tape applied to the surface.

5. The system of claim 1, wherein the design software application comprises computer-aided design software.

6. The system of claim 1, wherein the object comprises a line segment defining a path within a two-dimensional space, and further wherein the translation module generates instructions to cause the tape applicator to apply tape to the surface based on the defined path.

7. The system of claim 1, wherein the design software application outputs the design data based upon input received from a user.

8. The system of claim 1, wherein the translation module comprises a software module executing within the operating environment.

9. The system of claim 1, wherein the translation module comprises a hardware module.

10. The system of claim 1, wherein the design software application produces the design data to include a first object and a second object, and further wherein the translation module generates instructions to control a length of the tape and a path of the tape based on the first object, and further wherein the translation module generates instructions to cause the tape applicator to cut the tape based on the second object.

11. The system of claim 10, wherein the first object comprises a centerline, and the second object comprises a dashed line.

12. The system of claim 10, wherein the translation module generates instructions to cause the tape applicator to determine a length of a normal between an endpoint of the second object and the first object, and to select a width of tape based on the length of the normal.

13. A system comprising:
a translation module to generate instructions based on output design data from a computer-aided design software application; and
a tape applicator to apply tape to a surface in response to the instructions.

14. The system of clam 10, wherein the design data defines a set of objects within a multidimensional space

15. The system of claim 11, wherein the translation module generates instructions to cause the tape applicator to apply the tape along a path defined by a first object, and further wherein the translation module generates instructions to cause the tape applicator to cut the tape along a path defined by a second object.

16. The system of claim 15, wherein the first object comprises a centerline, and the second object comprises a dashed line.

17. The system of claim 13, wherein the objects define a set of paths within a two-dimensional space.

18. The system of claim 17, wherein the translation module identifies any intersecting paths and, for each intersection, generates instructions to cause the tape applicator to:
apply the tape to the surface along one of the intersecting paths,
cut the tape; and
apply tape along a different one of the intersecting paths.

19. The system of claim 18, wherein the translation module generates instructions to ensure a gap of at least a predefined width between the tape applied along the intersecting paths.

20. A method comprising:
receiving design data defining a set of objects within a multidimensional space;
generating instructions based one or more of the object; and
controlling a tape applicator to apply tape to a surface in response to the instructions.

21. The method of claim 20, wherein at least one of the object defines a first path within the multi-dimensional space, and generating instructions comprises generating instructions to cause the tape applicator to apply the tape to the surface along the first path.

22. The method of claim 21, wherein at least one of the objects defines a second path within the multi-dimensional space, and generating instructions comprises generating instructions to cause the tape applicator to cut the tape along the second path.

23. The method of claim 20, wherein generating instructions comprises:
generating instructions to cause the tape applicator to apply the tape along a path defined by a first object; and
generating instructions to cause the tape applicator to cut the tape along a path defined by a second object.

24. The method of claim 23, wherein the first object comprises a centerline, and the second object comprises a dashed line.

25. The method of claim 20, wherein receiving the design data definition comprises accessing an output file produced by the computer-aided design software application.

26. The method of claim 20, wherein generating instructions comprises parsing the design data to generate tape data describing tape segments and cut data describing cutting operations.

27. The method of claim 26, wherein generating instructions further comprises associating the cutting operations with the tape segments.

28. The method of claim 26, wherein generating instructions further comprises selecting a set of non-intersecting tape segments.

29. The method of claim 28, wherein generating instructions further comprises generating instructions to cause the tape applicator to:
apply the non-intersecting tape segments to the surface;
generating instructions to cause the tape applicator to cut the tape.

30. A computer-readable medium comprising instructions to cause a processor to:
receive design data defining a set of objects within a multidimensional space; and
based on the objects, generate instructions to control application of a tape to a surface.

31. The computer-readable medium of claim 30, wherein at least one of the objects comprises a line segment defining a path within the multidimensional space.

32. The computer-readable medium of claim 30, further comprising instructions to cause the processor to communicate the instructions to a tape applicator.

33. The computer-readable medium of claim 30, wherein at least one of the object defines a first path within the multi-dimensional space, and wherein the instructions cause the programmable processor to generate instructions to cause the tape applicator to apply the tape to the surface along the first path.

34. The computer-readable medium of claim 33, wherein at least one of the object defines a second path within the multi-dimensional space, and further wherein the instructions cause the programmable processor to generate instructions to cause the tape applicator to cut the tape along the second path.

35. The computer-readable medium of claim 30, wherein the instructions cause the programmable processor to generate instructions to:
generate instructions to cause the tape applicator to apply the tape along a path defined by a first object; and
generate instructions to cause the tape applicator to cut the tape along a path defined by a second object.
